(19) United States
(12) Patent Application Publication
(10) Pub. No.: US 2022/0205072 A1
(43) Pub. Date: Jun. 30, 2022

(54) CONTINUOUSLY CAST BOLT MADE OF AN ALUMINUM-BASED ALLOY, EXTRUDED PROFILE, AND METHOD FOR PRODUCING SAME

(71) Applicant: Hammerer Aluminium Industries Extrusion GmbH, Braunau am lnn-Ranshofen (AT)

(72) Inventor: Andreas SCHIFFL, Munderfing (AT)

(73) Assignee: Hammerer Aluminium Industries Extrusion GmbH, Braunau am Inn - Ranshofen (AT)

(21) Appl. No.: 17/601,311

(22) PCT Filed: Feb. 5, 2020
(86) PCT No.: PCT/AT2020/060031

§ 371 Date: Oct. 4, 2021

(30) Foreign Application Priority Data
Apr. 5, 2019 (AT) A 50301/2019

(51) Int. Cl. C22F 1/05; C22C 21/02; B22D 11/00; B21C 23/14

(52) U.S. Cl. CPC C22F 1/05; B21C 23/142; B22D 11/003; C22C 21/02

(57) ABSTRACT

The invention relates to a continuously cast bolt made of an aluminum-based alloy for an extruded profile that has a yield strength of greater than 260 MPa, preferably greater than 280 MPa, in particular greater than 300 MPa. According to the invention, it is provided that the aluminum-based alloy contains, in percentage by weight, greater than 0.0% to 0.40% iron, 0.40% to 1.2% magnesium, 0.60% to 1.1% silicon, greater than 0.0% to 0.35% copper, greater than 0.0% to 0.35% chromium, 0.40% to 0.95% manganese, up to 0.2% zinc, optionally 0.005% to 0.15% titanium and/or 0.005% to 0.15% titanium diboride, and a remainder of aluminum and production-related impurities, wherein a secondary dendrite arm spacing of the microstructure is less than 100 μm. The invention furthermore relates to an extruded profile created from a continuously cast bolt of this type, and to a method for producing an extruded profile.

The invention relates to a continuously cast bolt made of an aluminum-based alloy for an extruded profile that has a yield strength of more than 260 MPa, preferably more than 280 MPa, in particular more than 300 MPa.

The invention furthermore relates to an extruded profile, in particular a hollow profile such as a double hollow cavity profile, which can be obtained from a continuously cast bolt of this type.

The invention also relates to a method for producing an extruded profile.

Today, motor vehicles are often equipped with what are referred to as crash profiles, which are intended to help increase safety. The crash profiles are installed in energy absorbers, for example. The crash profiles are typically hollow profiles, for example double hollow cavity profiles. During an impact, these hollow cavity profiles absorb energy by deforming, whereby at least a portion of the impact energy is dissipated for the safety of the passenger or passengers.

Crash profiles of this type are intended to have optimal mechanical properties, in particular in terms of a yield strength, but in addition also to be temperature-resistant, since the crash profiles can also be located in proximity to the engine compartment and are therefore exposed to a higher temperature during operation. Even at higher temperatures, a functionality of the crash profiles should at least to a large extent be ensured. In addition, a corrosion resistance is also desirable in order that the crash profiles do not fail prematurely due to corrosion caused by external exposure.

Crash profiles as presented above are currently fabricated from aluminum alloys. From the aluminum alloys, continuously cast bolts are normally first created by casting a molten mass, which bolts are subjected to an extrusion following homogenization, in order to create crash profiles. A heat treatment of the crash profiles created in this manner can follow.

Automobile manufacturers require specific criteria for crash profiles from the producers and suppliers of crash profiles in internal company standards. The requirements for the materials and the crash profiles created therefrom are steadily increasing. This can be seen, for example, from the yield strength required, which is currently C24 for most profiles, which represents a yield strength of greater than 240 MPa. Prior to this, C20 had been sufficient (yield strength of greater than 200 MPa). At the present time, it can be expected that C28 and subsequently C32 will be increasingly required in the future, that is, yield strengths of greater than 280 MPa and greater than 320 MPa, respectively, as is currently already noted in a number of OEM specifications.

To satisfy these requirements, which have become stricter over time and will also become even more strict in the future, various aluminum-based alloys were developed, wherein these alloys are normally AlMgSi alloys. In WO 2013/162374 A1, an aluminum-based alloy of this type is described which is also intended to be able to adequately satisfy class C28. For this purpose, an adapted ratio of magnesium to silicon and specific content ranges of other alloying elements are proposed. The teaching of this document aims at the microstructure of the aluminum-based alloy not being recrystallized. However, due to the continuously increasing requirements noted, in particular with regard to a most perfect possible compression behavior even at high strengths, there are efforts to provide additional high-performance aluminum-based alloys, or continuously cast bolts made therefrom, for crash profiles.

Based on this prior art, the object of the invention is to specify a continuously cast bolt of the type named at the outset which allows the production of extruded profiles which have an optimal compression behavior in a compression specimen while also yielding high material characteristics.

Another object is to specify an extruded profile.

Furthermore, it is an object of the invention to specify a method of the type named at the outset with which extruded profiles of high quality can be produced for use in crash protection.

The object of the invention relating to a continuously cast bolt is attained with a continuously cast bolt of the type named at the outset, wherein the aluminum-based alloy contains, in percentage by weight,

greater than 0.0% to 0.40% iron,

0.40% to 1.2% magnesium,

0.60% to 1.1% silicon,

greater than 0.0% to 0.35% copper,

greater than 0.0% to 0.35% chromium,

0.40% to 0.95% manganese,

up to 0.2% zinc,

optionally 0.005% to 0.15% titanium and/or 0.005% to 0.15% titanium diboride,

aluminum and production-related impurities as a remainder,

wherein a secondary dendrite arm spacing of the microstructure is less than 100 μm.

Unless otherwise stated, the percentages below and the percentages that follow refer to percentage by weight.

A continuously cast bolt according to the invention is suitable for producing extruded profiles, in particular crash profiles for automobiles, which have a yield strength (R_{p0.2}) of at least 260 MPa, preferably at least 280 MPa, in particular greater than 300 MPa. In particular, the yield strength of a profile of this type can also be greater than 320 MPa. A continuously cast bolt according to the invention comprises a fine microstructure with a secondary dendrite arm spacing of less than 100 μm. This relatively fine microstructure is a prerequisite for the presence of a homogenized continuously cast bolt following a homogenization, which bolt can be used to produce extruded profiles with a recrystallized microstructure and thus excellent mechanical characteristics and good crash characteristics as well as high corrosion resistance.

The composition of the aluminum-based alloy for a continuously cast bolt according to the invention and the subsequent use thereof, following homogenization, for the extrusion of a profile such as a hollow cavity profile, in particular a double hollow cavity profile, with a recrystallized microstructure is based on the following considerations:

Magnesium (Mg) and silicon (Si), as well as copper (Cu), contribute greatly to the strength of the alloy. The alloying element manganese (Mn) has the added function of modifying the aluminum-iron-silicon phases (AlFeSi phases) which primarily precipitate during the casting. Because median iron (Fe) contents of approx. 0.2% are present in the frequently used type 6082 alloys and, therefore, a needle-like form of these AlFeSi phases can be expected. A moderate addition of manganese in the range from 0.40% to 0.95% ensures a spheroidization of the AlFeSi phases. Instead of long, needle-like phases, phases similar to Chinese script are precipitated. These are less disruptive during a subsequent forming and promote the creation of new grains during a subsequent recrystallization in an extrusion. Alloying elements such as titanium and/or compounds such as titanium diboride can in particular be added in order to further reduce a casting grain size and to refine a cellular structure. Furthermore, via a modification of casting conditions, such as high cooling rates for example, a casting grain size can also be further reduced.

During the homogenization of the continuously cast bolt, which is important for the equalization of microsegregation in the casting grains, the primarily precipitated beta AlFeSi phases are converted into alpha AlFeSi phases. This is a key process for the deformability of the AlFeSi phases. At the homogenization temperature and the correspondingly long length of time, the primarily precipitated MgSi phases are completely dissolved. During the heating to the homogenization temperature, the alloying elements Mn and Cr can be precipitated as dispersoids (AlFeSiMn, AlFeSiCr and/or AlFeSiMnCr). These dispersoids serve as what are referred to as recrystallization inhibitors during a subsequent extrusion or general forming, for example also during a forging. This does not mean that a recrystallization can be fully suppressed. Only the mobility of the grain boundaries, which move during the recrystallization, is inhibited by the dispersoids. As a result, a very small grain size emerges. For this purpose, as will be explained in greater detail below, a distribution of the size of the dispersoids can also be set via the homogenization.

It is preferable if the aluminum-based alloy contains 0.65% to 1.0%, preferably 0.70% to 0.95%, in particular 0.70% to 0.85% magnesium. Silicon is adjusted accordingly, wherein preferable silicon contents of 0.65% to 0.95%, preferably 0.70% to 0.90% can be present. In principle, it was shown within the scope of the invention that higher contents of both magnesium and also silicon, as well as a relatively high silicon-to-magnesium weight ratio of 0.90 to 1.20, preferably 0.95 to 1.15, in particular 1.00 to 1.10, tend to be preferred. In the corresponding content ranges, and possibly with a corresponding weight ratio of silicon to magnesium, good crash characteristics can be achieved. In these ranges, an optimum is achieved between a high ductility on the one hand and adequate strength on the other hand. Here, a very finely recrystallized microstructure is also achieved in the shift between the decrease in strength and increase in ductility, which is striven for as part of the invention.

An iron content is typically 0.05% to 0.35%, preferably 0.1% to 0.3%. The spheroidization of needle-like AlFeSi phases, which in themselves are potentially inherently disadvantageous, can, as previously explained, be achieved using manganese in the specified content ranges.

For copper, it has proven expedient to provide contents of 0.10% to 0.30%, preferably 0.12% to 0.25%. Chromium, which forms dispersoids in the interaction with manganese, is preferably provided in the content range from 0.10% to 0.30%.

Preferred ranges for manganese lie in the content range from 0.45% to 0.90%, preferably 0.50% to 0.85%, in particular 0.50% to 0.75%.

Impurities can be minimized. An impurity content should not be greater than 0.1 wt % per element, and should not be greater than 0.5 wt % in total.

A secondary dendrite arm spacing of the microstructure is advantageously less than 90 μm, preferably 20 μm to 80 μm, in particular 30 μm to 70 μm. It has been shown, including by the spheroidization of the AlFeSi phases, that both a grain size and also a dendrite arm spacing are small. The smaller the grain size and the smaller a dendrite arm spacing, the smaller and more homogeneous the distribution of the AlFeSi phases and all other primarily precipitated phases. A small grain size and a small secondary dendrite arm spacing coupled with the finely distributed primary phases are not insignificant for a further forming process, in particular an extrusion into a crash profile, and permit a fine microstructural formation in the extruded profile or crash profile.

A continuously cast bolt according to the invention is excellently suited to the production of an extruded profile, in particular a hollow profile such as a double hollow cavity profile.

Accordingly, in a further aspect, the invention provides an extruded profile, in particular a hollow profile such as a double hollow cavity profile, wherein a profile of this type can in particular constitute a crash profile of an automobile, or can be used for this purpose. A correspondingly extruded profile has a yield strength of greater than 260 MPa, preferably greater than 280 MPa, in particular greater than 300 MPa. The yield strength of the extruded profile can exceed 320 MPa.

Thus, in a further aspect of the invention, an extruded profile is provided, in particular a hollow profile such as a double hollow cavity profile, in particular created from a continuously cast bolt according to the invention, having a yield strength of greater than 260 MPa, preferably greater than 280 MPa, in particular greater than 300 MPa or 320 MPa, containing, in percentage by weight,

greater than 0.0% to 0.40% iron,

0.40% to 1.2% magnesium,

0.60% to 1.1% silicon,

greater than 0.0% to 0.35% copper,

greater than 0.0% to 0.35% chromium,

0.40% to 0.95% manganese,

up to 0.2% zinc,

optionally 0.005% to 0.15% titanium and/or 0.005% to 0.15% titanium diboride, aluminum and production-related impurities as a remainder,

wherein a microstructure is recrystallized.

The extruded profile can have a median microstructure grain size of less than 60 μm, preferably 2 μm to 50 μm, in particular 10 μm to 30 μm. This means that the extruded profile that is created from the homogenized continuously cast bolt forms a recrystallized microstructure during extrusion. With the AlFeSi phases, which are present in a continuously cast bolt according to the invention and are further reduced in size in the first step by a fine and homogeneous precipitation in the casting microstructure and in the second step by an extrusion, and are then distributed even more finely and homogeneously, starting seeds for a recrystallization are provided. Because of the dispersoids precipitated during the homogenization, however, the recrystallization is moderated to such an extent that a controlled, finely grained re-formation of the grains occurs. This can additionally be promoted by high degrees of deformation. The microstructure is essentially completely recrystallized.

After the extrusion, an extruded profile can be subjected to a heat treatment, as is typically used for aluminum-based alloy. For example, this can be a classic T6 heat treatment or artificial aging.

The other object of the invention is obtained with a method of the type named at the outset, wherein the following steps are provided:

a) production of a continuously cast bolt according to the invention;

b) homogenization of the continuously cast bolt;

c) extruding of the profile;

d) optional heat treatment of the extruded profile.

With a method according to the invention, an extruded profile can be provided which, in addition to exceptionally high strength values, also offers excellent crash characteristics and additionally has a sufficient corrosion resistance. The extruded profile comprises a recrystallized, fine, and homogeneous microstructure. As stated above, a median grain size of the microstructure is preferably less than 60 μm, for example 2 μm to 50 μm, in particular 10 μm to 30 μm. The grain sizes of the recrystallized microstructure in the extruded profile are smaller than those in the casting microstructure of the continuously cast bolt used for the extrusion, which is subjected to a homogenization beforehand. However, the secondary dendrite arm spacing of the microstructure is also relatively small in the continuously cast bolt, which can be achieved through corresponding casting conditions in combination with the alloy composition. Typical casting temperatures lie in the range from 670° C. to 720° C.; a casting speed when using Wagstaff molds is in the range from 50 mm/min to 110 mm/min. Grain refiners can be admixed on the scale of 1 kg/ton of aluminum to 3.5 kg/ton of aluminum in order to keep the microstructure as fine as possible. A scrap percentage is normally greater than 50%, and a hydrogen percentage is less than 15 mg/100 mL.

As explained previously, a correspondingly fine microstructure together with the formation of suitable AlFeSi phases and the subsequent formation of fine dispersoids through homogenization is a prerequisite for then obtaining the desired fine, homogeneous, and also recrystallized microstructure when the profile is extruded. This recrystallized microstructure yields not only a high strength, but, due to the fineness, also excellent crash characteristics and a good corrosion resistance.

A homogenization is preferably carried out at a temperature of 520° C. to 590° C., in particular 530° C. to 580° C. The homogenization can occur through a rapid heating, which in itself is typical, followed by a holding phase at a predetermined temperature, and a subsequent rapid cooling. A cooling preferably occurs with a temperature gradient of at least 500 K/h, in particular at least 700 K/h. It is also possible, and has proven advantageous in terms of a finest possible formation of dispersoids, to initially heat to a first temperature, to then keep the continuously cast bolt at this first temperature for a specific length of time in a holding phase, and afterwards to provide another heating to a second, higher temperature, whereupon a holding phase once again follows before a rapid cooling takes place, for example through air cooling and/or water cooling, or using a spray mist. The homogenization can thus occur in a single-stage or two-stage manner with a first and second holding temperature. Typical heating rates range from 1 K/min to 10 K/min for a bolt with a 12-inch diameter. If a first stage with a first holding temperature is provided, then this holding temperature lies in the range from 200° C. to 375° C. The holding duration at this first temperature lies in the range from 0.5 to 3 hours. In addition, it is also even possible to set the size and distribution of the dispersoids via a choice of temperature within predefined temperature windows.

The extruding in step c) occurs with a highest possible degree of deformation. The degree of deformation can be greater than 30, preferably 40 or greater, in particular 50 or greater. It can thereby be provided that, in the extrusion die, additional guiding means are provided with which the material being extruded is diverted in order to thereby locally achieve an even greater degree of deformation. This is beneficial to a finest possible recrystallized microstructure in the profile that is created.

The homogenization can take place for a duration of three to six hours. The continuously cast bolt can subsequently be heated to a temperature above 400° C. prior to the extruding, in order to then extrude the profile at this temperature.

Following the extrusion of the profile, the profile can be subjected to a heat treatment, for example a T6 heat treatment.

Additional features, advantages and effects of the invention follow from the exemplary embodiments described below. In the drawings which are thereby referenced:

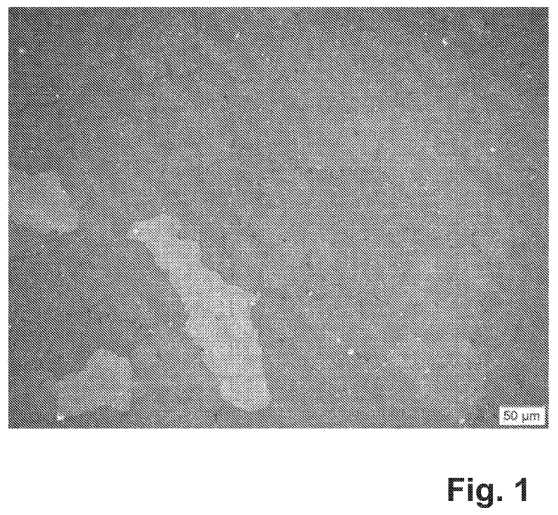

FIG. 1 shows an exemplary microstructural image of a continuously cast bolt according to the invention;

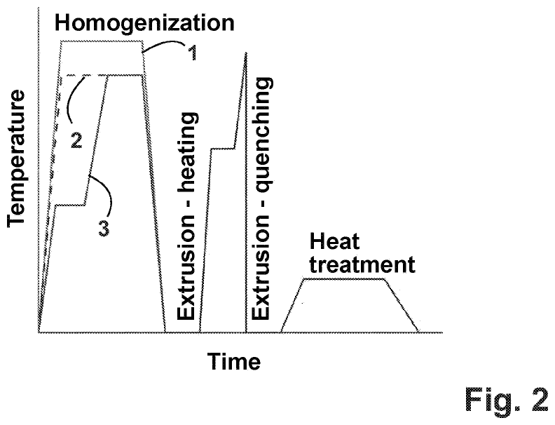

FIG. 2 shows a chart relating to the temperature progression during a production of an extruded profile;

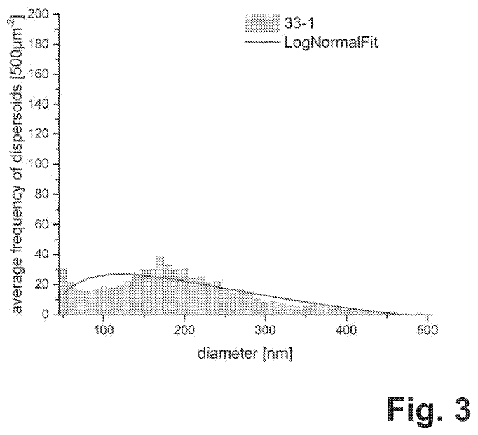

FIG. 3 shows a first distribution of dispersoids;

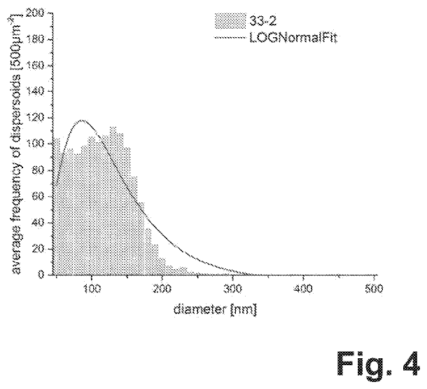

FIG. 4 shows a second distribution of dispersoids;

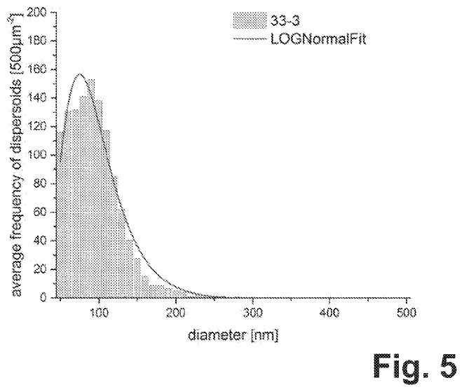

FIG. 5 shows a third distribution of dispersoids;

FIG. 6 shows an exemplary cross-section of a profile according to the invention;

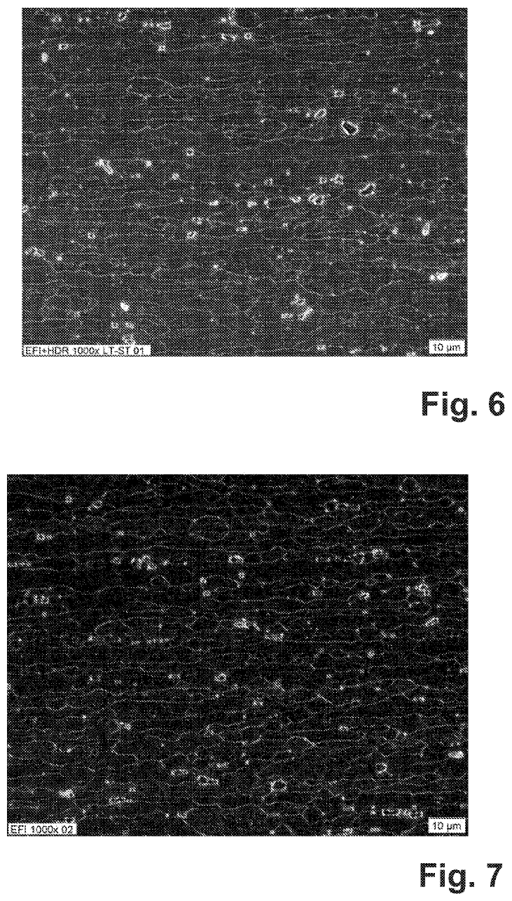

FIG. 7 shows an exemplary longitudinal section of a profile according to the invention;

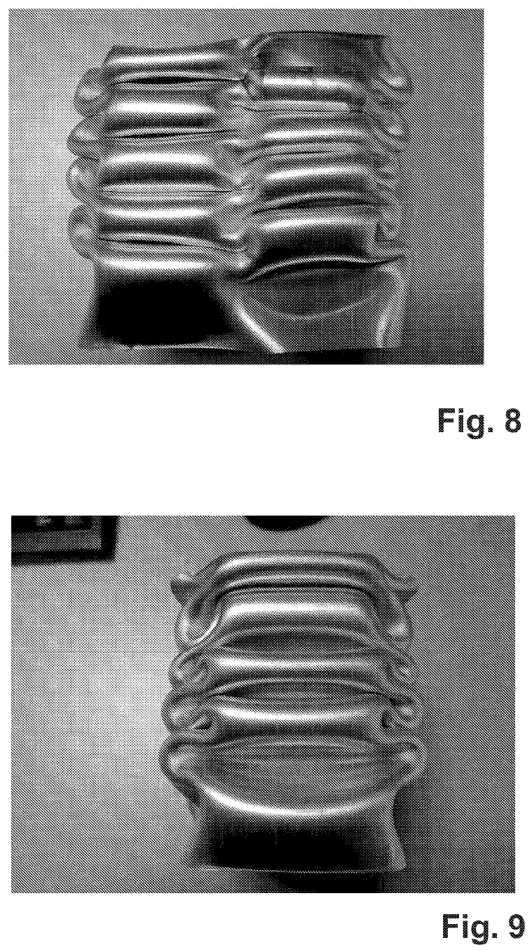

FIG. 8 shows a frontal view of an exemplary compression specimen from a double hollow cavity profile;

FIG. 9 shows an exemplary compression specimen in a side view from a double hollow cavity profile;

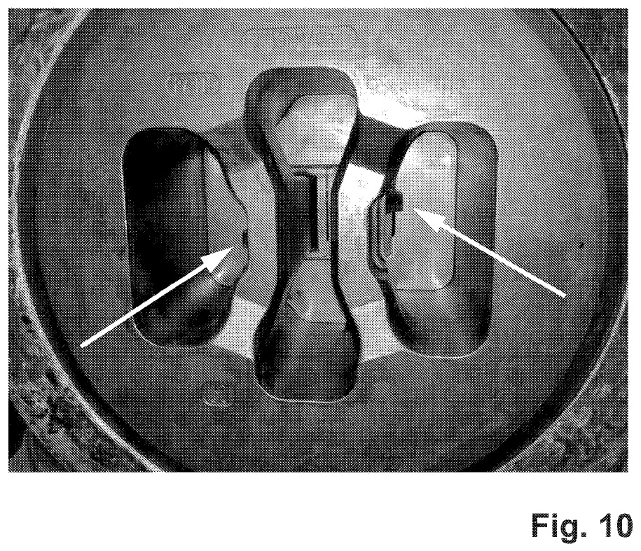

FIG. 10 shows a top view of a die for extruding a profile.

In FIG. 1, an exemplary and typical structural image is shown of a continuously cast bolt as created according to the invention. This continuously cast bolt has a secondary dendrite arm spacing, measured and determined according to the German Casting Industry Association (BDG) guideline and German Foundrymen's Association (VDG) reference sheet P 220, of roughly 50 μm. The continuously cast bolt is then homogenized, preferably in the temperature range from 530° C. to 580° C. A homogenization duration is roughly three to six hours for continuously cast bolts with a diameter of approximately 10 to 12 inches. During this homogenization, different temperature programs can be run, as are shown by way of example in FIG. 2. Depending on the chemical composition of the continuously cast bolt, the distribution of dispersoids can be set via the homogenization temperature and via the progression of the temperature ramps. This can be seen in FIG. 3 through FIG. 5 for the three homogenization progressions illustrated in FIG. 2. In particular, it can also be seen that, with a decreasing temperature from the first homogenization progression to the second homogenization progression according to FIG. 3 and FIG. 4, a more defined distribution with a smaller average dispersoid diameter is obtained. Finally, according to FIG. 5, a tighter distribution that is even more definitive, with an even smaller average dispersoid diameter, can be obtained via the third homogenization progression, which proceeds in a two-stage manner with a first temperature ramp and a second temperature ramp.

In addition to the continuously cast bolt as shown in FIG. 1, an extruded profile be created following a homogenization. In particular, hollow cavity profiles, for example double hollow cavity profiles, can be created, such as those required for installation in motor vehicles in particular.

In Table 1 shown below, exemplary alloys and the accompanying material characteristics are indicated. As can be seen, in the case of extrusion based on the given compositions, crash profiles that have a yield strength of greater than 290 MPa are obtained. A recrystallization of the microstructure thereby occurs during the extrusion. Whereas the microstructure in the continuously cast bolt from FIG. 1 has a secondary dendrite arm spacing of approximately 50 μm, the grain size in the microstructure of the extruded profile is markedly smaller and also homogeneous. This can clearly be seen by reference to FIG. 6 (cross-section) and FIG. 7 (longitudinal section). In particular, the longitudinal section along the extrusion direction shows that the microstructure is recrystallized. If this were not the case, there would have to be what is referred to as a “pancake structure” given the high degrees of deformation upwards of 50-fold, which is not the case.

TABLE 1
Compositions and material characteristics of profiles according to the invention

| | | | | | | | R_{p0.2} | Rₘ | A |
|---|---|---|---|---|---|---|---|---|---|
| Class | Si | Fe | Cu | Mn | Mg | Cr | [MPa] | [MPa] | [%] |
| C32 | 0.85 | 0.18 | 0.12 | 0.55 | 0.80 | 0.12 | 334 | 352 | 12.6 |
| C32 | 0.88 | 0.22 | 0.2 | 0.62 | 0.79 | 0.17 | 342 | 356 | 11.5 |
| C28 | 0.79 | 0.17 | 0.15 | 0.6 | 0.75 | 0.18 | 305 | 330 | 13.2 |
| C28 | 0.74 | 0.2 | 0.2 | 0.70 | 0.72 | 0.2 | 290 | 315 | 11.3 |

In FIG. 8 and FIG. 9, an exemplary compression specimen of one of the alloys according to Table 1 is shown in a frontal view (FIG. 8) and side view (FIG. 9). The compression specimen shows, following a standardized compression text, virtually no cracks and thus satisfies the conditions required by automotive manufacturers.

According to examinations for intracrystalline corrosion, there were no signs of a corrosive attack in profiles according to Table 1 in an artificially aged condition (heat treatment of the profiles for 3 hours at 215° C. and 8 hours at 180° C.) under exposure to test solutions. The profiles thus also meet the conditions in terms of a highest possible corrosion resistance.

An extruded profile as discussed above is created using a die such as that illustrated in FIG. 10. The die itself is a typical die for an extrusion of a double hollow cavity profile. In contrast to the prior art, however, additional guiding means are also provided in direct proximity to the profile-shaping passage, which guiding means divert the material being extruded. The guiding means are located in the positions marked by the arrows in FIG. 10. With the guiding means, an even higher degree of deformation is achieved locally, which is highly beneficial to a fine microstructure. Local forming is also drastically increased by the guiding means. Consequently, this local forming causes a greatly increased dislocation density. The increased dislocation density, paired with the potential starting seeds for recrystallization (AlFeSi phases), enables the start of recrystallization. Through the targeted influencing of the dispersoids (size and distribution) during the heating to the homogenization temperature, the recrystallization can be optimally controlled and regulated (see FIG. 6 and FIG. 7 for a perfect end result). Thus, in a further aspect, the invention relates to a die for extruding a hollow profile, in particular a double hollow cavity profile, preferably for carrying out a method as explained above, wherein in the die, in addition to multiple cavities for receiving a continuously cast bolt in a branching manner before a profile-shaping die, additional guiding means are provided for diverting the extruded material. With the additionally provided single or plural guiding means, a dislocation density can be increased so that by providing starting seeds, a regulation of the recrystallized grain size using dispersoids or the distribution and density thereof and the dislocation density, an optimized microstructure can be achieved.

1. A continuously cast bolt made of an aluminum-based alloy for an extruded profile which has a yield strength of greater than 260 MPa, preferably greater than 280 MPa, in particular greater than 300 MPa, containing, in percentage by weight,
greater than 0.0% to 0.40% iron,
0.40% to 1.2% magnesium,
0.60% to 0.95% silicon,
greater than 0.0% to 0.35% copper,
greater than 0.0% to 0.35% chromium,
0.40% to 0.95% manganese,
up to 0.2% zinc,
optionally 0.005% to 0.15% titanium and/or 0.005% to 0.15% titanium diboride,
aluminum and production-related impurities as a remainder,
wherein a secondary dendrite arm spacing of the microstructure is less than 100 μm.

2. The continuously cast bolt according to claim 1, containing 0.65% to 1.0%, preferably 0.70% to 0.95%, in particular 0.70% to 0.85%, magnesium.

3. The continuously cast bolt according to claim 1, containing 0.65% to 0.95%, preferably 0.70% to 0.90%, silicon.

4. The continuously cast bolt according to claim 1, wherein a weight ratio of silicon to magnesium is 0.90 to 1.20, preferably 0.95 to 1.15, in particular 1.00 to 1.10.

5. The continuously cast bolt according to claim 1, containing 0.05% to 0.35%, preferably 0.1% to 0.3%, iron.

6. The continuously cast bolt according to claim 1, containing 0.10% to 0.30%, preferably 0.12% to 0.25%, copper.

7. The continuously cast bolt according to claim 1, containing 0.10% to 0.30%, preferably 0.10 to 0.25%, chromium.

8. The continuously cast bolt according to claim 1, containing 0.45% to 0.90%, preferably 0.50% to 0.85%, in particular 0.50% to 0.75%, manganese.

9. The continuously cast bolt according to claim 1, wherein the secondary dendrite arm spacing of the microstructure is less than 90 μm, preferably 20 μm to 80 μm, in particular 30 μm to 70 μm.

10. An extruded profile, in particular a hollow profile such as a double hollow cavity profile, in particular obtainable from a continuously cast bolt according to claim 1, having a yield strength of greater than 260 MPa, preferably
greater than 280 MPa, in particular greater than 300 MPa, containing, in percentage by weight,
greater than 0.0% to 0.40% iron,
0.40% to 1.2% magnesium,
0.60% to 0.95% silicon,
greater than 0.0% to 0.35% copper,
greater than 0.0% to 0.35% chromium,
0.40% to 0.95% manganese,
up to 0.2% zinc,
optionally 0.005% to 0.15% titanium and/or 0.005% to 0.15% titanium diboride,
aluminum and production-related impurities as a remainder,
wherein a microstructure is recrystallized.

11. The extruded profile according to claim 10, wherein a median grain size of the microstructure is less than 60 μm, preferably 2 μm to 50 μm, in particular 10 μm to 30 μm.

12. The extruded profile according to claim 10, wherein the profile is heat treated.

13. A method for producing an extruded profile, in particular a profile according to claim 10, comprising:
a) production of the continuously cast bolt;
b) homogenization of the continuously cast bolt;
c) extruding of the profile;
d) optional heat treatment of the extruded profile.

14. The method according to claim 13, wherein the homogenization is carried out at a temperature of 520° C. to 590° C., in particular 530° C. to 580° C.

15. The method according to claim 13, wherein the homogenization takes place for a duration of 3 to 6 hours.

16. The method according to claim 13, wherein the continuously cast bolt is heated to a temperature above 400° C. prior to the extruding.
